(19) United States
(12) Patent Application Publication
(10) Pub. No.: US 2024/0112256 A1
(43) Pub. Date: Apr. 4, 2024

(54) FINANCIAL SERVICE PROVISION SYSTEM AND SIMPLE PAYMENT COMPANY SERVER THEREFOR

(71) Applicant: KAKAOPAY CORP., Seongnam-si, Gyeonggi-do (KR)

(72) Inventors: Seokgeun Park, Incheon (KR); Jaehee Kim, Seoul (KR); Duk Cho, Anyang-si (KR); Kyuhyen Hwang, Seongnam-si (KR); Soohyun Kim, Seoul (KR); Sangjoon Yoon, Seongnam-si (KR); Seonghwan Lee, Seongnam-si (KR)

(73) Assignee: KAKAOPAY CORP., Seongnam-si, Gyeonggi-do (KR)

(21) Appl. No.: 18/262,220

(22) PCT Filed: Jan. 21, 2022
(86) PCT No.: PCT/KR2022/001127

§ 371 Date: Jul. 20, 2023

(30) Foreign Application Priority Data
Jan. 21, 2021 (KR) 10-2021-0008732

(51) Int. Cl. G06Q 40/02; G06Q 20/02

(52) U.S. Cl. CPC G06Q 40/02; G06Q 20/02

(57) ABSTRACT

The present technology relates to a financial service provision system and a simple payment company server therefor. A financial service provision system of the present technology is a financial service provision system for providing a financial service of attracting funds from customer-linked accounts to manage customer financial company accounts, and comprises: a simple payment company server including a first parent account system including one or more first parent accounts; a financial company server including a second parent account system including one or more second parent accounts; a bank firm system which manages the transfer of funds between the customer-linked account and the first mother account system or between the customer-designated account designated by the customer and the first parent account system; and a securities firm system which manages the transfer of funds between the second parent account system and the financial company account of the customer, and which uses the bank firm system and the securities firm system to change the balance of the financial company account of the customer if the customer requests a change in balance. The present technology can provide: a financial service provision system in which a prepaid electronic payment means method and a comprehensive securities account method are linked to each other; and a simple payment company server therefor.

### TECHNICAL FIELD

The present invention relates to a financial service provision system and a simple payment company server therefor, and more particularly, to a financial service provision system in which a prepaid electronic payment means method and a comprehensive securities account method are linked, and a simple payment company server therefor.

### BACKGROUND ART

Prepaid electronic payment means is a certificate issued by electronically storing transferable monetary value or information about the certificate and is means used to purchase and pay for goods and services from and to a third party other than an issuer.

As the fintech market grows, companies are also launching their own prepaid electronic payment means services one after another. Kakao Pay Money, Toss Money, T-money, and the like are the launching prepaid electronic payment means services. The companies are working hard to preoccupy the market.

The prepaid electronic payment means have a set usage limit. According to the relevant laws, the usage limit is currently KRW 2 million. When remitting, the amount exceeding KRW 2 million may not be remitted, and the holding amount may not exceed KRW 2 million. Recently, discussions on increasing this limit are ongoing, but it is the same in that the limit is set.

Meanwhile, even if the limit increases, there is a burden on consumers to deposit a large amount of money because the deposited amount is not protected by the Depositor Protection Act. In addition, no interest is accrued on funds deposited in the prepaid electronic payment means. The prepaid electronic payment means does not generate so-called cash flows. This is one of the reasons that the prepaid electronic payment fails to attract consumers.

Meanwhile, a comprehensive securities account may be considered.

The comprehensive securities account may solve several problems of the above-described prepaid electronic payment means. The comprehensive securities account refers to a financial product, which can be deposited and withdrawn at any time, allows merchant banks to manage money deposited by customers on notes, debt bonds, and the like, and pay the profits to the customers, and have no restrictions on the above usage limits and are subject to the Depositor Protection Act. Consumers may also receive deposit fees.

However, the comprehensive securities account is not as convenient to use as the prepaid electronic payment means. Accordingly, the comprehensive securities account has limitations in not addressing the need for a simple payment method. This is because transfer service is provided by logging in with an accredited certificate and following the prescribed procedure, just like a normal bank transaction. The procedure is complicated and inconvenient to use, so it does not conform to the trend of the global fintech market.

Research is required to develop a model that can be used for both the convenience of payment of the prepaid electronic payment means and the benefits of cash flow management such as the comprehensive securities account.

The inventors of the present invention have completed the present invention after long research and trial and error in order to solve these limitations.

### DISCLOSURE

### Technical Problem

An embodiment of the present invention provides a financial service provision system in which a prepaid electronic payment means method and a comprehensive securities account method are linked to each other; and a simple payment company server therefor.

Meanwhile, other objects not specified in the present invention may be additionally considered within the scope that can be easily inferred from the following detailed description and effects thereof.

### Technical Solution

According to an embodiment of the present invention, a financial service provision system for providing a financial service of attracting funds from customer-linked accounts to manage customer financial company accounts includes a simple payment company server that includes a first parent account system including one or more first parent accounts, a financial company server that includes a second parent account system including one or more second parent accounts, a bank firm system that manages a transfer of funds between the customer-linked account and the first parent account system or between a customer-designated account designated by a customer and the first parent account system, and a securities firm system that manages the transfer of funds between the second parent account system and the customer financial company account, in which, when the customer requests a change in balance, the change in balance may be processed through the bank firm system and the securities firm system to change the balance of the customer financial company account.

The financial service provision system may further include a balance increase processing unit that performs processing of withdrawing the funds from the customer-linked account using the bank firm system and processing of increasing the balance of the customer financial company account using the securities firm system processing unit, when the customer requests an increase in the balance, and a balance deduction processing unit that performs processing of remitting the funds to the customer-designated account using the bank firm system and processing of deducting the balance of the customer financial company account using the securities firm system when the customer requests balance deduction.

The first parent accounts may include a withdrawal firm parent account, a collection parent account, and a deposit firm parent account, and the second parent accounts may include a financial company parent account.

The balance increase processing unit may include a message generating unit that generates a balance increase request-related message, a bank firm execution unit that executes the bank firm system based on the message to transfer the funds from the customer-linked account to the withdrawal firm parent account, and a securities firm execution unit that executes the securities firm system based on the message to increase the balance of the customer financial company account through a transfer transaction between the financial company parent account and the customer financial company account.

The balance increase processing unit may further include a first request recording unit that records a request in a bank firm-request log based on the generated message, a first processing result receiving unit that receives a transfer of funds processing result according to the execution of the bank firm system, and a first request processing result reflection unit that reflects the received processing result in the bank firm-request log.

The balance increase processing unit may further include a second request recording unit that records a request in a securities firm-request log based on the generated message, a second processing result receiving unit that receives a balance increase processing result according to the execution of the securities firm system, and a second request processing result reflection unit that reflects the received processing result in the securities firm-request log.

The balance increase processing unit may further include a failed case search unit that searches for a failed request of which the processing result is recorded as failure in the securities firm-request log, and a reprocessing process unit that performs a reprocessing process on the failed request by the second request recording unit, the second processing result receiving unit, and the second request processing result reflection unit.

The balance increase processing unit may further include a non-reflected case search unit that searches for a non-reflected request of which the processing result is not reflected in the securities firm-request log, and a non-reflected case processing unit that confirms whether the balance increases according to the execution of the securities firm system for the non-reflected request by the securities firm execution unit, changes a state of the non-reflected case to a success state when the balance increases as a result of the confirmation, and changes the state of the non-reflected case to a failure state when the balance is not increased.

The balance deduction processing unit may include a message generation unit that generates a balance deduction request-related message, a bank firm execution unit that executes the bank firm system based on the message to transfer the funds from the deposit firm parent account to the customer-designated account, and a securities firm execution unit that executes the securities firm system based on the message to deduct the balance of the financial company parent account through a transfer transaction between the financial company parent account and the customer financial company account.

The balance deduction processing unit may further include a first request recording unit that records a request in a securities firm-request log based on the generated message, a first processing result receiving unit that receives a balance deduction processing result according to the execution of the securities firm system, and a first request processing result reflection unit that reflects the received processing result in the securities firm-request log.

The balance deduction processing unit may further include a second request recording unit that records a request in a bank firm-request log based on the generated message, a second processing result receiving unit that receives a transfer of funds processing result according to the execution of the bank firm system, and a second request processing result reflection unit that reflects the received processing result in the bank firm-request log.

The balance deduction processing unit may further include a failed case search unit that searches for a failed request of which the processing result is recorded as failure in the bank firm-request log, and a recovery process unit that performs a recovery process of recovering the deducted balance of the customer financial company account on the failed request.

The balance deduction processing unit may further include a non-reflected case search unit that searches for a non-reflected request of which the processing result is not reflected in the bank firm-request log, and a non-reflected case processing unit that confirms whether the transfer of the funds is performed according to the execution of the bank firm system by the bank firm execution unit for the non-reflected request, changes a state of the non-reflected case to a success state hen the transfer of the funds is performed as a result of the confirmation, and changes state of the non-reflected case to a failure state when the transfer of the funds is not performed.

The first parent account system may include a plurality of withdrawal firm parent accounts issued by different financial companies, and the bank firm system may process the transfer of the funds using a withdrawal firm parent account issued by the same financial company as the customer-linked account among the plurality of withdrawal firm parent accounts.

According to another embodiment of the present invention, a simple payment company server for providing a financial service of attracting funds from a customer-linked account to deposit the attracted funds into a customer financial company account, in which the simple payment company server may be connected, through a network, to a financial company server that includes a first parent account system that includes one or more first parent accounts and a second parent account system that includes one or more second parent accounts, and when a customer requests a change in balance, a balance of the customer financial company account may be changed through a bank firm system that manages a transfer of funds between the customer-linked account and the first parent account system or a transfer of funds between a customer-designated account designated by the customer and the first parent account system and a securities firm system that manages a transfer of funds between the second parent account system and the customer financial company account.

According to still another embodiment of the present invention, a financial company server for providing a financial service of attracting funds from a customer-linked account to deposit the attracted funds into a customer financial company account, in which the financial company server may be connected, through a network, to a simple payment company server that includes a first parent account system that includes one or more first parent accounts; and a second parent account system that includes one or more second parent accounts, and when a customer requests a change in balance, a balance of the customer financial company account may be changed through a bank firm system that manages a transfer of funds between the customer-linked account and the first parent account system or a transfer of funds between a customer-designated account designated by the customer and the first parent account system and a securities firm system that manages a transfer of funds between the second parent account system and the customer financial company account.

### Advantageous Effects

According to the present technology, it is possible to provide a financial service in which a prepaid electronic payment means method and a comprehensive securities account method are linked to each other.

In addition, according to the present technology, it is possible to provide a simple payment method that is not limited by the usage limit of the existing prepaid electronic payment means.

In addition, according to the present technology, it is possible to provide new financial services capable of providing the convenience of simple payment like the existing prepaid electronic payment means and also providing various account-based services such as remittance and transfer, and generating profits from fund management through deposits.

### DESCRIPTION OF DRAWINGS

FIG. 1 is a diagram illustrating a conceptual diagram of a financial service provision system according to an embodiment of the present invention.

FIG. 2 is a diagram illustrating an overall configuration of the financial service provision system according to the embodiment of the present invention.

FIGS. 3A and 3B are diagrams respectively illustrating detailed configurations of a first parent account system and a second parent account system according to embodiments of the present invention.

FIG. 4 is a diagram conceptually illustrating cash flows appearing in the financial service provision system according to the embodiment of the present invention.

FIG. 5 is a diagram illustrating a detailed configuration of a balance increase processing unit according to an embodiment of the present invention.

FIG. 6 is a flowchart illustrating an operation of the balance increase processing unit according to an embodiment of the present invention, centering on a bank firm.

FIG. 7 is a flowchart illustrating an operation of the balance increase processing unit according to the embodiment of the present invention, centering on a securities firm.

FIG. 8 is a diagram illustrating an overall flow of a process in which a balance of a customer financial company account is increased and processed by the balance increase processing unit according to the embodiment of the present invention.

FIG. 9 is a diagram illustrating a detailed configuration of a balance deduction processing unit according to an embodiment of the present invention.

FIG. 10 is a flowchart illustrating an operation of the balance deduction processing unit according to the embodiment of the present invention, centering on the securities firm.

FIG. 11 is a flowchart illustrating the operation of the balance deduction processing unit according to the embodiment of the present invention, centering on the bank firm.

FIG. 12 is a diagram illustrating an overall flow of a process in which a balance of the customer financial company account is deducted and processed by the balance deduction processing unit according to the embodiment of the present invention.

FIG. 13 is a diagram illustrating in detail operations of a non-reflected case search unit and a non-reflected case processing unit with respect to a securities firm-request log according to an embodiment of the present invention.

FIG. 14 is a diagram illustrating in detail operations of a non-reflected case search unit and a non-reflected case processing unit with respect to a bank firm-request log according to an embodiment of the present invention.

FIG. 15 is a diagram illustrating in detail operations of a failed case search unit and a reprocessing process unit according to an embodiment of the present invention.

It is to be noted that the accompanying drawings are illustrated as references for understanding the technical idea of the present invention, and the scope of the present invention is not limited thereto.

### BEST MODE

Hereinafter, the most exemplary embodiment of the present invention is described. In the drawings, the thickness and interval are expressed for convenience of explanation, and may be exaggerated compared to the actual physical thickness. In describing the present invention, well-known configurations irrelevant to the gist of the present invention may be omitted. In adding reference numerals to components throughout the drawings, it is to be noted that like reference numerals designate like components even though components are shown in different drawings.

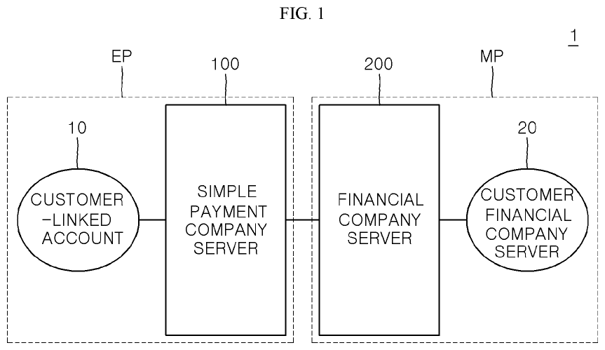

FIG. 1 is a diagram illustrating a conceptual diagram of a financial service provision system according to an embodiment of the present invention.

As illustrated in FIG. 1, a financial service provision system 1 includes a simple payment company area EP and a financial company area MP.

The financial service provision system 1 may perform the same function as the existing prepaid electronic payment means through the simple payment company area EP. It is possible to use services of easy payment, remittance, and transfer within a usage limit of the prepaid electronic payment means prescribed by the law. To this end, the simple payment company area EP includes a customer-linked account 10 and a simple payment company server 100. The simple payment company server may draw funds from customer-linked accounts and also remit the funds to the customer-linked accounts. Although only the customer-linked account is illustrated in the drawings, funds may be transferred to a designated account to which a customer requests remittance.

As will be described below, the simple payment company server 100 operates by being linked to a financial company server 200. The simple payment company server 100 and the financial company server 200 may be connected through a wired or wireless communication network. The customer-linked account 10 is a commercial bank account being used by a customer. Funds are attracted from the customer-linked account to the simple payment company server according to an embodiment of the present invention.

The financial service provision system 1 may perform the same function as the existing comprehensive securities account through the financial company area MP. It is possible to use account-based remittance and transfer services without limiting the usage limit of the prepaid electronic payment means. To this end, the financial company area MP includes a customer financial company account 20 and the financial company server 200. The financial company server is responsible for deposits into and withdrawals from customer financial company accounts.

As will be described below, the financial company server 200 operates by being linked to the simple payment company server 100. A customer financial company account 20 is a commercial financial company account that a customer is using. For example, when the financial company is a securities company, it may be a securities account opened in the securities company. Alternatively, when the financial company is a bank, it may be a bank account opened in the bank. The present invention is not limited to the term, and any account that is not limited to the same limit as in the prepaid electronic payment means may be used. The funds of the financial service provision system according to an embodiment of the present invention are deposited into the customer financial company account and managed.

The financial service provision system according to an embodiment of the present invention proposes a linking method between the simple payment company domain EP and the financial company domain MP, thereby solving the problem of a holding limit and transfer limit of the existing prepaid electronic payment means and also improving the convenience of payment. Like the existing comprehensive securities account, it is possible to use account-based services such as remittance, transfer, and firm banking, and provide management profits. In addition, the Depositor Protection Act is applied.

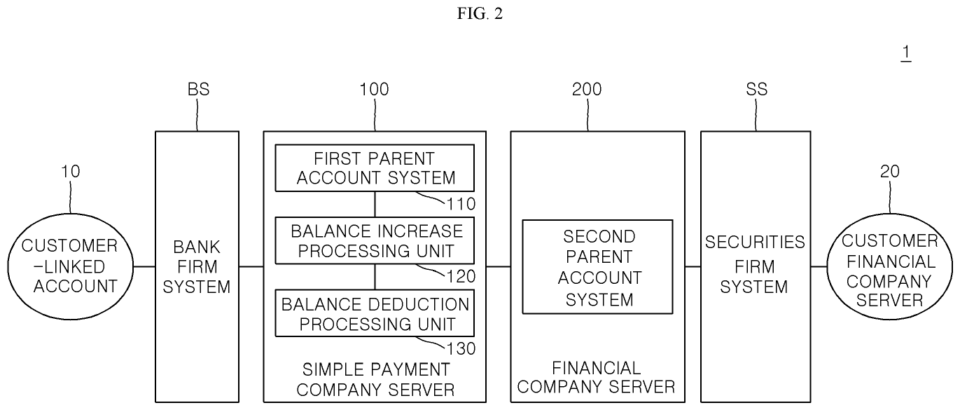

Hereinafter, a method of linking a simple payment company area and a financial company area according to the present invention will be described in more detail with reference to FIGS. 2 to 15.

FIG. 2 is a diagram illustrating an overall configuration of the financial service provision system 1 according to the embodiment of the present invention.

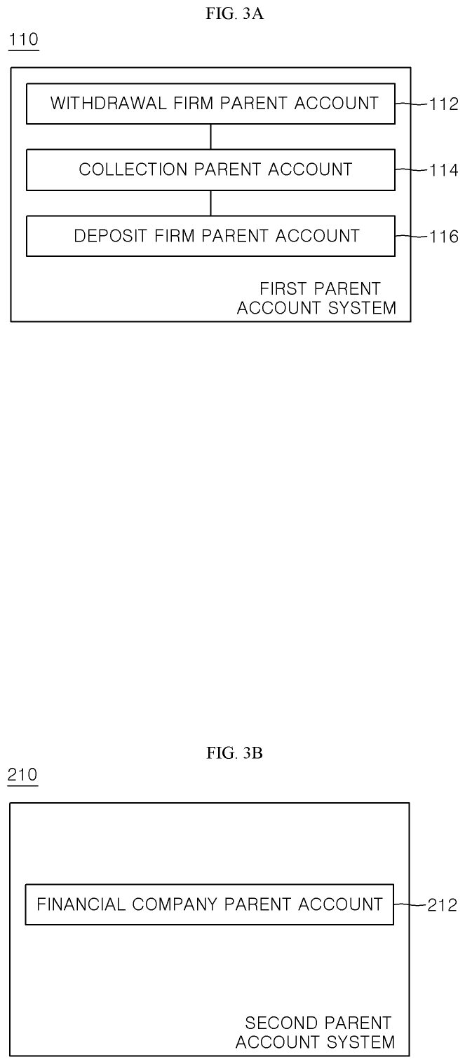

FIGS. 3A and 3B are diagrams respectively illustrating detailed configurations of a first parent account system and a second parent account system according to embodiments of the present invention.

As illustrated in FIG. 2, the financial service provision system 1 (hereinafter simply referred to as “financial system”) includes the simple payment company server 100, the financial company server 200, a bank firm system BS, a securities firm system SS, the customer-linked account 10, and the customer financial company account 20.

The simple payment company server 100 may include a first parent account system 110, a balance increase processing unit 120, and a balance deduction processing unit 130. The present invention mainly describes an embodiment in which a simple payment company server includes a balance increase processing unit and a balance deduction processing unit, but is not limited thereto, and the balance increase processing unit and the balance deduction processing unit may be included in a financial system.

The financial company server 200 may include a second parent account system 210.

As illustrated in FIG. 3A, the first parent account system 110 of the simple payment company server may include a withdrawal firm parent account 112, a collection parent account 114, and a deposit firm parent account 116.

As illustrated in FIG. 3B, the second parent account system 210 of the financial company server may include a financial company parent account 212. The second parent account system may further include a financial company deposit parent account (not illustrated), which will be described below.

It will be described in more detail with reference to FIGS. 2 to 3B.

First, the withdrawal firm parent account 112 withdraws funds from the customer-linked account 10 and holds the funds. There are multiple withdrawal firm parent accounts for each domestic financial company. When 24 financial institutions are providing financial services in Korea, 24 withdrawal firm parent accounts may exist. The withdrawal firm parent account may be an account issued by each financial institution (e.g., a bank). Multiple withdrawal firm parent accounts for each financial company reduce transfer fees and increase security and stability. An accountholder of the withdrawal firm parent account may be a name of a company operating a financial system according to an embodiment of the present invention. When a financial system operator is a simple payment company, it may be a name of the simple payment company. When the financial system operator is a financial company, it may be a name of the financial company.

Withdrawing funds from the withdrawal firm parent account 112 may be performed at the time when the customer requested the balance increase or in real time. The collection parent account 114 draws and holds funds collected in the withdrawal firm parent account 112. The number of withdrawal firm parent accounts is two or more, but the number of collection parent accounts is one. It may be an account issued by a financial company (e.g., a bank) that has make an agreement with a simple payment company according to an embodiment of the present invention. Multiple accounts may be prepared, if necessary, but the single collection parent account increases the efficiency of deposit received management. A name of the collection parent account may be a name of a company (i.e., simple payment company) that operates a simple payment company server according to an embodiment of the present invention.

Drawing funds to the collection parent account 114 from the withdrawal firm parent account 112 may be performed at any time regardless of the time of the balance increase request of the customer.

The collection parent account always holds a balance, and thus, as described below, it is possible to increase or deduct the balance in real time according to the request of the customer regardless of the internal transfer operation.

The collection parent account serves as a deposit received account for providing financial services according to an embodiment of the present invention. The collection parent account may be viewed as a deposit received account for the role of the prepaid electronic payment means in the financial system.

The deposit firm parent account 116 deposits fund into the customer-designated account that the customer designates to receive remittances. There are multiple deposit firm parent accounts for each domestic financial company. However, in order to receive instructions from the simple payment company server of the present invention and enable deposit processing, it is preferable that the account be issued by a financial company that provides services such as firm banking. Alternatively, it may be an account issued by a financial company (e.g., a bank) that has entered into an agreement with a simple payment company according to an embodiment of the present invention. For example, there may be three deposit firm parent accounts. Multiple deposit firm parent accounts for each financial company reduce transfer fees and increase security and stability. A name of the deposit firm parent account may be a name of the simple payment company according to an embodiment of the present invention.

Depositing funds through the deposit firm parent account 116 may be performed at the time when the customer requests the balance deduction or in real time.

In addition, drawing funds to the deposit firm parent account from the collection parent account may be performed at any time regardless of the time of the balance deduction request of the customer.

The financial company parent account 212 draws and holds the funds collected in the collection parent account 114. The number of financial company parent accounts may be one. It may be an account issued by a company (i.e., a financial company) that operates a financial company server according to an embodiment of the present invention. Multiple accounts may be prepared, if necessary, but a single financial company parent account increases the efficiency of deposit received management. The name of the deposit firm parent account may be the name of the simple payment company according to an embodiment of the present invention. Note that the names of the collection parent account and the financial company parent account are the same.

Drawing funds to the financial company parent account 212 from the collection parent account 114 may be performed at any time regardless of the time of the balance increase request of the customer or balance deduction request.

The financial company parent account always holds a balance, and thus, as described below, it is possible to increase or deduct the balance in real time according to the request of the customer regardless of the internal transfer operation.

The financial company parent account serves as another deposit received account for providing financial services according to an embodiment of the present invention. The financial company parent account may be viewed as a deposit received account for a role of a comprehensive securities account in the financial system.

Meanwhile, the second parent account system may further include a financial company deposit parent account (not illustrated) as it is a financial company area, and the financial company deposit parent account may serve as a deposit received base of the financial company itself. The financial company deposit parent account may be an account issued by a financial company (e.g., a bank) that has entered into an agreement with the financial company according to an embodiment of the present invention. It may be an account issued by a financial company, such as the financial company that issued the collection parent account. It is advantageous in terms of fee reduction and security. The financial company deposit parent account may be in the name of the financial company. Meanwhile, when the financial system operator is the simple payment company, it may be the name of the simple payment company.

The bank firm system BS is a system that manages the transfer processing. The bank firm system may include a communication channel that is involved in a transfer of funds between the customer-linked account 10 and the first parent account system 110 or a transfer of funds between the customer-designated account designated by the customer and the first parent account system 110.

In detail, the bank firm system BS may perform a transfer of funds between the customer-linked account 10 and the withdrawal firm parent account 112 or a transfer of funds between the deposit firm parent account 116 and the customer-designated account.

That is, the bank firm system manages a function of drawing funds from the customer-linked account to the first parent account system or sending funds from the first parent account system to the customer-designated account.

The securities firm system SS is also a system that manages the transfer processing. The securities firm system SS may include a communication channel that is involved in a transfer of funds between the second parent account system 210 and the customer financial company account 20.

In detail, the securities firm system SS may perform the transfer of funds between the second parent account system 210 and the customer financial company account 20.

That is, the securities firm system manages a function of sending funds from the second parent account system to the customer financial company account or withdrawing funds from the customer financial company account to the second parent account system.

Subsequently, referring to FIGS. 2 to 3B, the balance increase processing unit 120 performs processing of increasing the balance of the customer financial company account using the above-described bank firm system and securities firm system when the customer requests the balance increase. The balance deduction processing unit 130 performs processing of deducting the balance of the customer financial company account using the above-described bank firm system and securities firm system when the customer request the balance deduction.

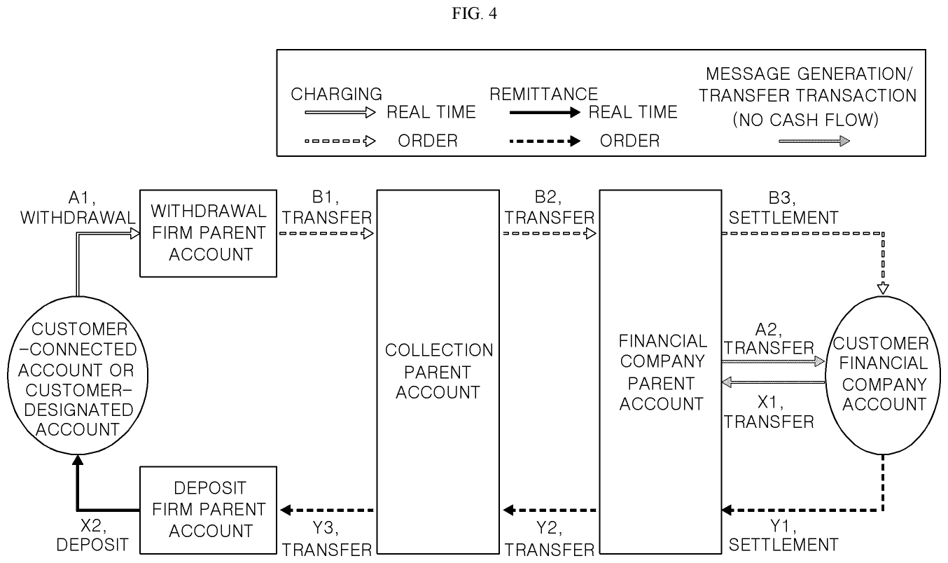

Hereinafter, referring to FIG. 4, a process of processing, by the balance increase processing unit and the balance deduction processing unit, of the balance increase and the balance deduction using the bank firm system and the securities firm system will be described in more detail.

Meanwhile, examples of the balance deduction request of the customer may include remittance, transfer, or the like to another account. In any case, it is common in that the balance of the customer financial company account is deducted. Therefore, in the present invention, reference is made to the balance deduction request by paying attention to the balance deduction for various requests from customers. Similarly, examples of the balance increase request of the customer may include charging, or the like. In any case, in the present invention, reference is made to the balance increase request by paying attention to the balance increase for various requests from customers in that the balance of the customer financial company account is increased.

FIG. 4 is a diagram conceptually illustrating cash flows appearing in the financial service provision system according to the embodiment of the present invention.

First, the balance increase processing process will be described.

The balance increase means that funds are withdrawn from a customer-connected account and put into the customer financial company account. That is, it means charging. The charged balance is shown to customers through a smartphone app or the like. That is, the balance of the customer financial company account is shown to a user.

For the balance increase request, a customer may use a charging graphic user interface (GUI) implemented through the smartphone app.

When the balance increase request is made, a related slip is generated. The message may be generated in the smartphone app and transmitted to the simple payment company server, or the simple payment company server managing the smartphone app may receive related information and directly generate the related information. The message may include information about transaction details. For example, information about a customer account number, a charge request date, a charge request number, a charge amount, and the like may be included.

Referring to FIG. 4, when the customer requests the balance increase, withdrawal is made from the customer-linked account to the withdrawal firm parent account in real time with the request (A1, withdrawal) (execution of the bank firm system). In addition, transfer processing is performed between the financial company parent account and the customer financial company account in real time (A2, transfer) (execution of the securities firm system).

Through processes A1 and A2, the charging may be made in real time with the balance increase request of the customer.

Meanwhile, after the balance increase request of the customer, an internal settlement process is performed sequentially. That is, cash flow occurs from the withdrawal firm parent account to the collection parent account (B1, transfer), cash flow occurs from the collection parent account to the financial company parent account (B2, transfer), and cash flow occurs from the financial company parent account to the customer financial company account (B3, settlement). In this way, the balance increase processing process is completed. The order of B1 to B3 is arbitrary. This is because the withdrawal firm parent account, the collection parent account, and the financial company parent account have deposit received. That is, it always holds a balance.

Next, the balance deduction processing process will be described.

The balance deduction refers to the withdrawal of funds from the customer financial company account and the remittance to the customer-designated account. That is, it means the remittance. It includes remittances (transfer to other banks, payment, etc.) for various reasons. The deducted balance is shown to the customers through the smartphone app or the like. That is, the balance of the customer financial company account is shown to a user.

For the balance deduction request, customers may use the remittance GUI implemented through the smartphone app.

When requesting the balance deduction, a related message is generated. The message may be generated in the smartphone app and transmitted to the simple payment company server, or the simple payment company server managing the smartphone app may receive related information and directly generate the related information. The message may include information about transaction details. For example, information about a customer account number, a transfer request date, a transfer request number, a transfer amount, a transfer financial institution code, a transfer financial institution account number, a recipient name, and the like may be included.

Referring to FIG. 4, when the customer request the balance deduction, transfer processing is performed between the financial company parent account and the customer financial company account in real time with the request (X1, transfer) (execution of the securities firm system). In addition, real-time deposit is performed from the deposit firm parent account to the customer-designated account in real time therewith (X2, deposit) (execution of the bank firm system).

Through the processes X1 and X2, the remittance may be made in real time with the balance deduction request of the customer.

Meanwhile, after the balance deduction request of the customer, the internal settlement process is performed sequentially. That is, cash flow occurs from the customer financial company account to the financial company parent account (Y1, settlement), cash flow occurs from the financial company parent account to the collection parent account (Y2, transfer), and cash flow occurs from the collection parent account to the deposit firm parent account (Y3, transfer). In this way, the balance increase processing process is completed. The order of Y1 to Y3 is arbitrary. This is because the deposit firm parent account, the collection parent account, and the financial company parent account have deposit received. That is, it always holds a balance.

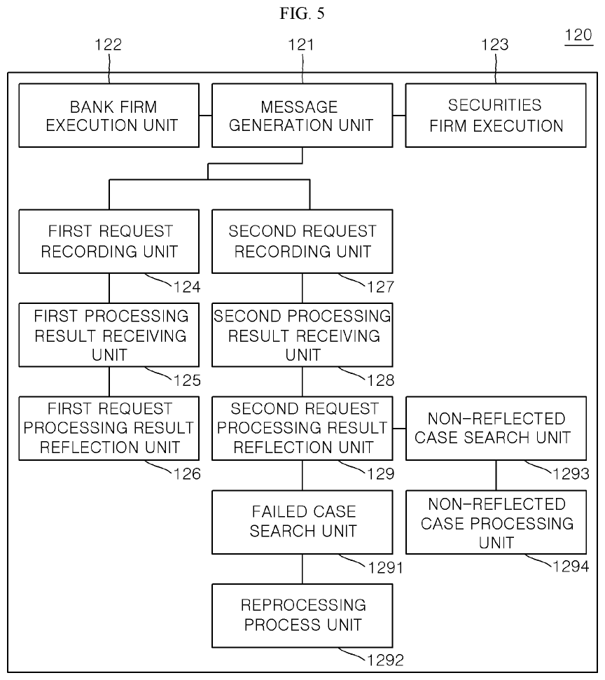

Hereinafter, configurations of the balance increase processing unit and the balance deduction processing unit that generate message generation/transfer transaction and cash flow as described above will be described in more detail with reference to FIGS. 5 to 15.

FIG. 5 is a diagram illustrating a detailed configuration of the balance increase processing unit 120 according to an embodiment of the present invention.

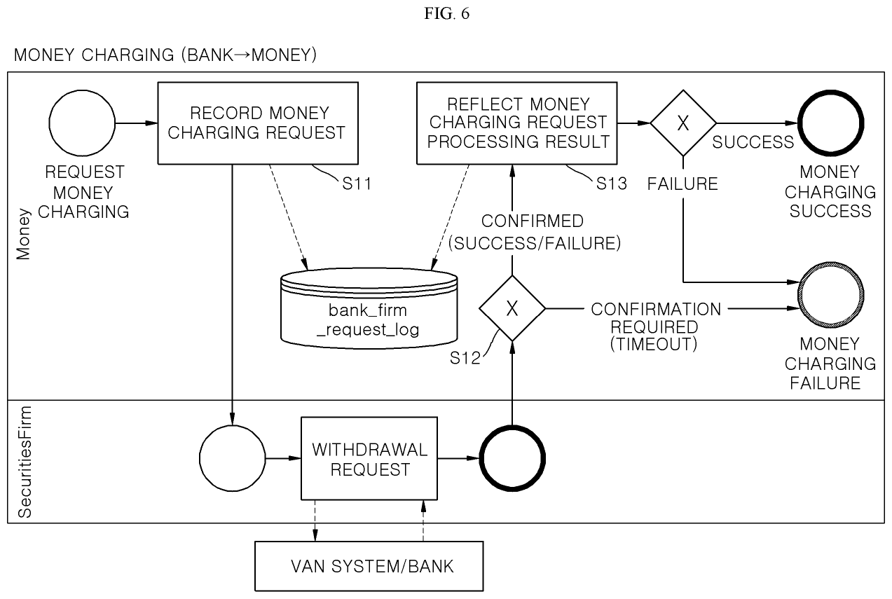

FIG. 6 is a flowchart illustrating an operation of the balance increase processing unit according to the embodiment of the present invention, centering on a bank firm.

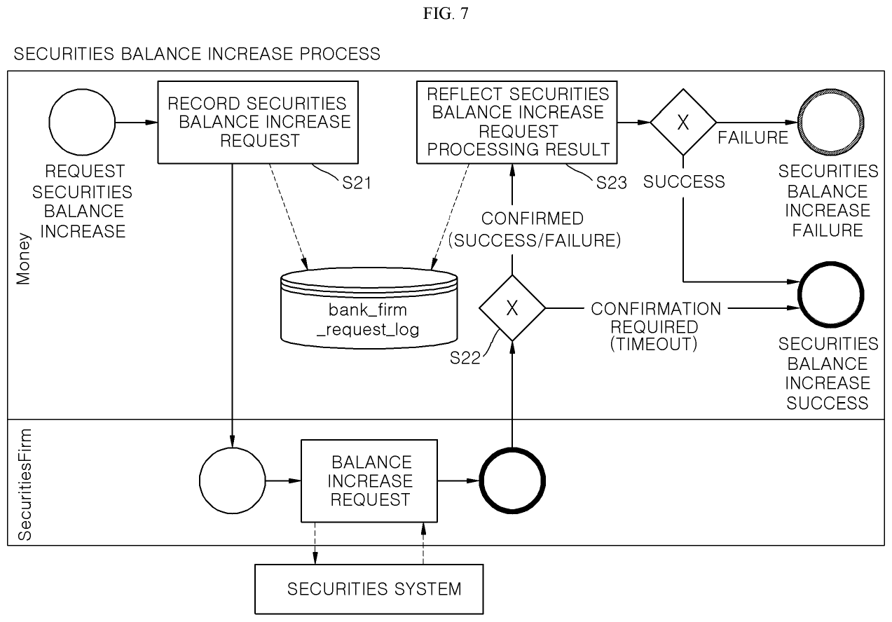

FIG. 7 is a flowchart illustrating an operation of the balance increase processing unit according to the embodiment of the present invention, centering on a securities firm.

First, as illustrated in FIG. 5, the balance increase processing unit 120 may include a message generation unit 121, a bank firm execution unit 122, a securities firm execution unit 123, a first request recording unit 124, a first processing result receiving unit 125, a first request processing result reflection unit 126, a second request recording unit 127, a second processing result receiving unit 128, a second request processing result reflection unit 129, a failed case search unit 1291, a reprocessing process unit 1292, a non-reflected case search unit 1293, and a non-reflected case processing unit 1294.

Basically, the message generation unit 121 generates a related message when the customer requests the balance increase. The bank firm execution unit 122 executes the bank firm system based on the generated message to transfer funds from the customer-linked account to the withdrawal firm parent account. The securities firm execution unit 123 executes the securities firm system based on the generated message to increase the balance of the customer financial company account through the transfer transaction between the financial company parent account and the customer financial company account.

Hereinafter, FIG. 6 is also referenced together with FIG. 5.

FIG. 6 illustrates the bank firm-centered operation in the balance increase processing, and reference is made to the term “money charge (bankmoney)” in the drawing in that funds are drawn from the customer-linked account (e.g., bank) to the first parent account system (e.g., money). Here, money may refer to a part of a financial service according to an embodiment of the present invention. In addition, money may refer to a unit (for example, point or gold) of currency used in financial services according to an embodiment of the present invention (of course, it may correspond to a unit of actual currency used in each country).

The first request recording unit 124 records the request in a bank firm request log (bank_firm_request_log) based on the generated message (S11). In the drawing, it is illustrated as the money charging request record.

Meanwhile, as described above, the bank firm execution unit 122 executes the bank firm system BS based on the message generated by the message generation unit 121 to transfer funds from the customer-linked account 10 to the withdrawal firm parent account 112. It is illustrated as a Van system/bank and a withdrawal request at the bottom of the drawing.

Subsequently, the first processing result receiving unit 125 receives a transfer of funds result (success/failure) according to the execution of the bank firm system (S12).

The first request processing result reflection unit 126 reflects the received processing result in the bank firm request log (S13). When the received processing result succeeds, the state is reflected as success for the recording. In the drawing, the money charging is illustrated as success. When the received processing result fails, the state is reflected as failure for the corresponding record. In the drawing, the money charging is illustrated as failure.

Meanwhile, in the process of transmitting and receiving the processing result, transmission or reception may be failed due to some problems. There may be various causes such as a problem on the transmitting side, a problem on the receiving side, a smartphone error, or an application operation error. Therefore, a case in which a transfer of funds result is not received within a predetermined time period due to such a problem may occur. It is illustrated as a timeout in the drawing. In this case, it cannot wait indefinitely, and for subsequent processing, it may be regarded as success or failure, but according to an embodiment of the present invention, it may be regarded as money charging failure. Since no process that can return in the procedure has been performed, it is regarded as failure to simplify the entire procedure.

As will be described below, when the money charging fails, the balance increase process is no longer performed and ends. The process of increasing the balance ends because the withdrawal from the customer-linked account (for example, a bank) fails.

Conversely, when the money charging succeeds, the balance increase process continuously proceeds.

Hereinafter, FIG. 7 is referred to.

FIG. 7 illustrates a securities firm-centered operation when processing the balance increase, and reference is made to the term “securities balance increase process” in the drawing in that the balance of the customer financial company account (e.g., a securities account) is increased by drawing funds from the second parent account system (e.g., a securities system).

The second request recording unit 127 records the request in a securities firm request log (securities firm request log) based on the generated message (S21). In the drawing, it is illustrated as the securities balance increase request record.

Meanwhile, it is as described above that the securities firm execution unit 123 executes the securities firm system SS based on the message generated by the message generation unit 121 to increase the balance of the customer financial company account through the transfer transaction between the financial company parent account 212 and the customer financial company account 20. The securities system and the balance increase request are illustrated at the bottom of the drawing.

Subsequently, the second processing result receiving unit 128 receives the balance increase processing result according to the execution of the securities firm system (S22).

The second request processing result reflection unit 129 reflects the received processing result in the securities firm request log (S23). When the received processing result succeeds, the state is reflected as success for the recording. In the drawing, the securities balance increase is illustrated as success. When the received processing result fails, the state is reflected as failure for the corresponding record. In the drawing, the securities balance increase is illustrated as failure.

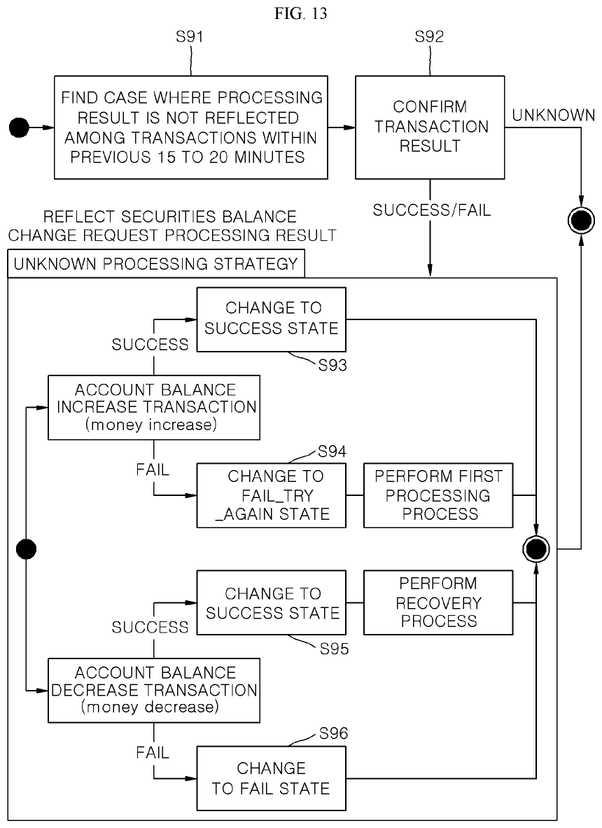

Meanwhile, a case in which the balance increase processing result is not received within a predetermined time due to any problems as described above may occur. It is illustrated as a timeout in the drawing. In this case, for subsequent processing, it may be regarded as success or failure, and according to an embodiment of the present invention, the securities balance increase may be regarded as success Note that the above-described operations S11 to S13 are the opposite of being processed as a failure in case of timeout. In the former case, this is because no process that can return is performed. In the latter case, since the money charging process has already been performed, the securities balance increase is once processed as success to quickly return the desired result (i.e., charging has been completed normally) to a user. However, since no processing result is reflected in the corresponding request, the internal procedure for processing this is required, which can be performed by the non-reflected case search unit 1293 and the non-reflected case processing unit 1294. It will be described below with reference to FIG. 13.

As will be described below, when the securities balance increase fails, a reprocessing process is performed. Since the withdrawal has already been made from the customer-linked account, the reprocessing process is performed without ending the procedure. The reprocessing process corresponds to the process of reflecting the funds already brought in the securities account.

Conversely, when the securities balance increase succeeds, the procedure ends as charging success.

Hereinafter, the entire flow including the above-described process of FIG. 6 and process of FIG. 7 will be described.

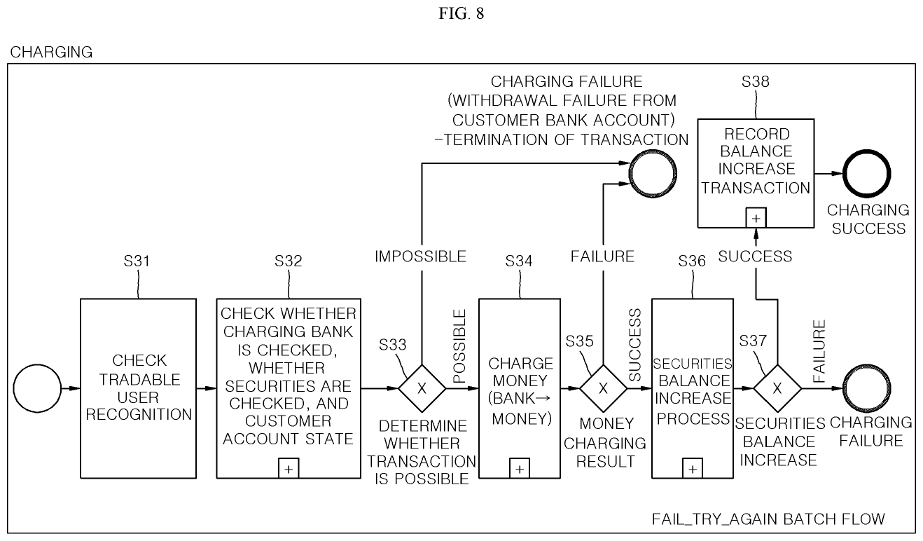

FIG. 8 is a diagram illustrating the overall flow of a process in which a balance of a customer financial company account is increased and processed by the balance increase processing unit according to the embodiment of the present invention.

Reference is made to the term ‘charging’ in that FIG. 8 illustrates a process of withdrawing funds from the customer-linked account (for example, a bank) and depositing the funds into the customer financial company account (for example, a securities account) through the first parent account system (for example, money).

Referring to FIG. 8, first, it is determined whether a user is valid. As an example, an operation S31 of checking whether the user is a tradable user may be performed.

Next, it is determined whether the account is valid. For example, an operation S32 of checking whether the bank linked to the customer-linked account is checked, whether the securities company linked to the customer financial company account is checked, and the state of the customer-linked account may be performed.

The user validity and account validity may be determined based on a previously generated message. The message may be generated by the message generation unit.

It is determined whether the transaction is possible (S33).

As a result of the determination, when the transaction is possible, it proceeds to an operation including the money charging process of FIG. 6 and the securities balance increasing process of FIG. 7 described above. As a result of the determination, when the transaction is impossible, the transaction is terminated. It is illustrated as the charging failure at the top of the drawing. This is a first embodiment of a charging failure, and corresponds to a withdrawal failure from a customer bank account.

Next, the money charging process is performed (S34). In the drawing, it is illustrated as the money charging (bankmoney). Operation S34 corresponds to the money charging process of FIG. 6 described above. That is, the above-described operations S11 to S13 may be performed.

Operation S34 may be performed by the bank firm execution unit 122. Operations S11 to S13 may be performed by the first request recording unit 124, the first processing result receiving unit 125, and the first request processing result reflection unit 126.

The money charging result is determined (S35).

As a result of the determination, when the money charging succeeds, the transaction continuously proceeds. As a result of the determination, when the money charging fails, the transaction is terminated. It is illustrated as the charging failure at the top of the drawing. This is a second embodiment of the charging failure, and corresponds to the withdrawal failure from the customer bank account.

Subsequently, the securities balance increase process is performed (S36). Operation S36 corresponds to the securities balance increase process in FIG. 7 described above. That is, the above-described operations S21 to S23 may be performed.

Operation S36 may be performed by the securities firm execution unit 123. Operations S21 to S23 may be performed by the second request recording unit 127, the second processing result receiving unit 128, and the second request processing result reflection unit 129.

The securities balance increase result is determined (S37).

As a result of the determination, when the securities balance increase succeeds, the charging succeeds and thus the transaction is terminated. In this case, a balance increase transaction recording operation S38 may be additionally performed.

As a result of the determination, when the securities balance increase fails, the charging fails and thus the transaction is terminated. However, the reprocessing process may be performed. Since the success is achieved through the reprocessing process to be described below, the guidance to the user may be charging success. As described above, since the withdrawal has already been made from the customer-linked account, the reprocessing process is performed without immediately terminating the transaction. This is a third embodiment of the charging failure, and corresponds to a case in which withdrawals have been made from the customer bank account but failed to be reflected in the securities account. When it ends in this state, the reprocessing process may be performed until the deposit into the securities account succeeds. It is illustrated as FAIL_TRY_AGAIN batch flow in the drawing. The reprocessing process will be described below.

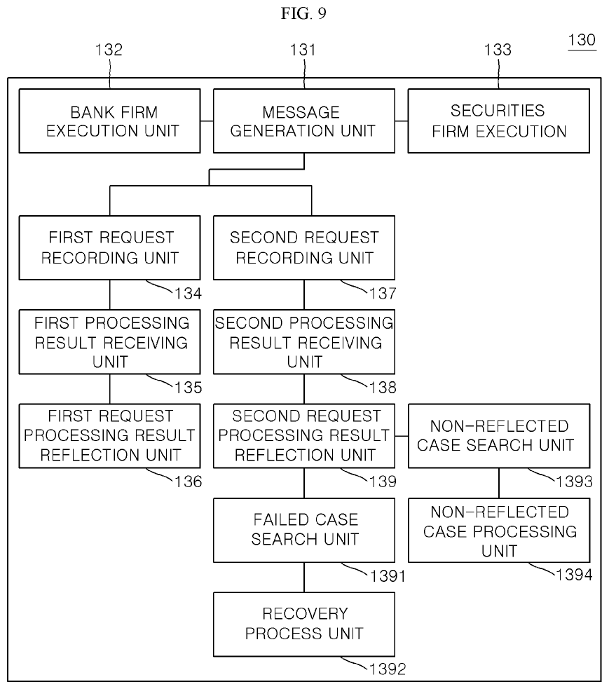

FIG. 9 is a diagram illustrating a detailed configuration of the balance deduction processing unit 130 according to an embodiment of the present invention.

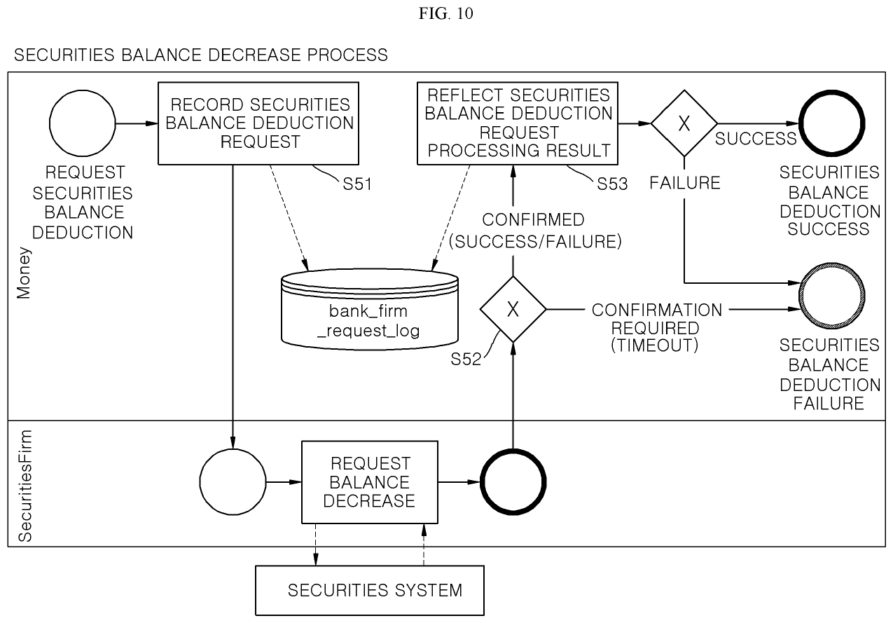

FIG. 10 is a flowchart illustrating an operation of the balance deduction processing unit according to the embodiment of the present invention, centering on the securities firm.

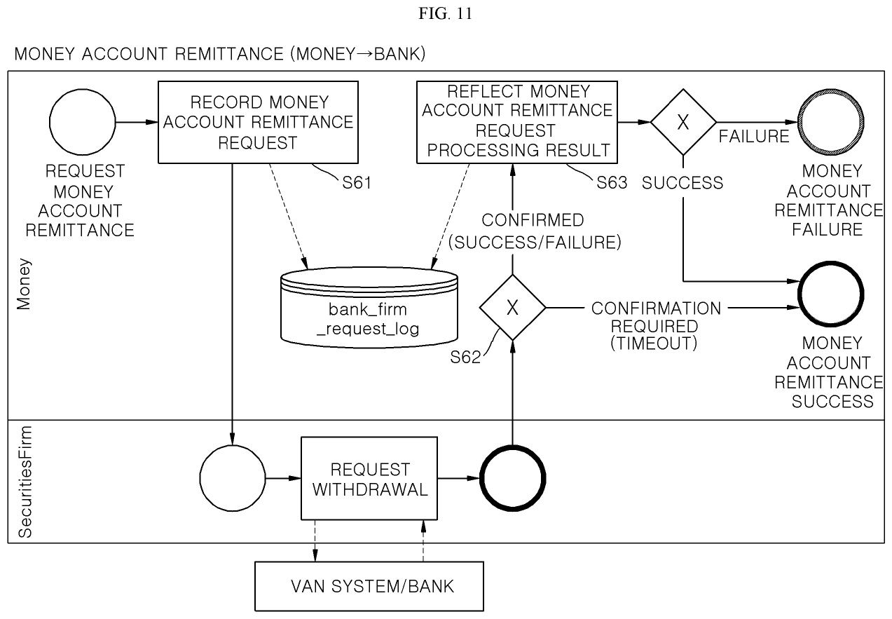

FIG. 11 is a flowchart illustrating the operation of the balance deduction processing unit according to the embodiment of the present invention, centering on the bank firm.

Note that, unlike the above-described FIGS. 6 and 7, the securities firm is first illustrated.

First, as illustrated in FIG. 9, the balance deduction processing unit 130 may include a message generation unit 131, a bank firm execution unit 132, a securities firm execution unit 133, a first request recording unit 134, a first processing result receiving unit 135, a first request processing result reflection unit 136, a second request recording unit 137, a second processing result receiving unit 138, a second request processing result reflection unit 139, a failed case search unit 1391, a recovery unit 1392, a non-reflected case search unit 1393, and a non-reflected case processing unit 1394.

Basically, the message generation unit 131 generates a related message when the customer requests the balance deduction. The bank firm execution unit 132 executes the bank firm system based on the generated message to transfer funds from the deposit firm parent account to the customer-designated account. The securities firm execution unit 133 executes the securities firm system based on the generated message to deduct the balance of the customer financial company account through the transfer transaction between the financial company parent account and the customer financial company account.

Hereinafter, FIG. 10 is also referenced together with FIG. 9.

FIG. 10 illustrates a securities firm-centered operation when processing the balance deduction, and reference is made to the term “securities balance decrease process” in the drawing in that the balance of the customer financial company account (e.g., a securities account) is decreased by sending funds from the second parent account system (e.g., a securities system).

The first request recording unit 134 records the request in a securities firm request log (securities_firm_request_log) based on the generated message (S51). In the drawing, it is illustrated as the securities balance deduction request record.

Meanwhile, as described above, that the securities firm execution unit 133 executes the securities firm system SS based on the message generated by the message generation unit 131 to deduct the balance of the customer financial company account through the transfer transaction between the financial company parent account 212 and the customer financial company account 20. In the drawing, it is illustrated as the securities system and the balance decrease request.

Subsequently, the first processing result receiving unit 135 receives the balance deduction processing result according to the execution of the securities firm system (S52).

The first request processing result reflection unit 136 reflects the received processing result in the securities firm request log (S53). When the received processing result succeeds, the state is reflected as success for the recording. In the drawing, the securities balance increase is illustrated as success. When the received processing result fails, the state is reflected as failure for the corresponding record. In the drawing, the securities balance deduction is illustrated as failure.

Meanwhile, a case in which the balance deduction processing result is not received within a predetermined time due to any problems as described above may occur. It is illustrated as a timeout in the drawing. In this case, the securities balance deduction may be regarded as failure. Since no process that can be reversed in the procedure has been performed, it is regarded as failure to simplify the entire procedure.

As will be described below, when the securities balance deduction fails, the balance deduction process is no longer performed and ends. The balance deduction process ends because the balance deduction from the customer financial company account (for example, customer balance) has failed.

Conversely, if the securities balance deduction is success, the balance deduction process continuously proceeds.

Hereinafter, FIG. 11 is referred to.

FIG. 11 illustrates the bank firm-centered operation in the balance deduction processing, and reference is made to the term “money account remittance (money→bank)” in the drawing in that funds are sent from the first parent account system (e.g., money) to the customer-designated account (e.g., bank).

The second request recording unit 137 records the request in the bank firm request log (bank_firm_request_log) based on the generated message (S61). In the drawing, it is illustrated as the money account remittance request record.

Meanwhile, it is as described above that the bank firm execution unit 132 executes the bank firm system BS based on the message generated by the message generation unit 131 to transfer funds from the deposit firm parent account 116 to the customer-designated account 10. It is illustrated as the Van system/bank and remittance request at the bottom of the drawing.

Subsequently, the second processing result receiving unit 138 receives a transfer of funds result (success/failure) according to the execution of the bank firm system (S62).

The second request processing result reflection unit 139 reflects the received processing result in the bank firm request log (S63). When the received processing result succeeds, the state is reflected as success for the recording. In the drawing, the money charging is illustrated as success. When the received processing result fails, the state is reflected as failure for the corresponding record. In the drawing, the money charging is illustrated as failure.

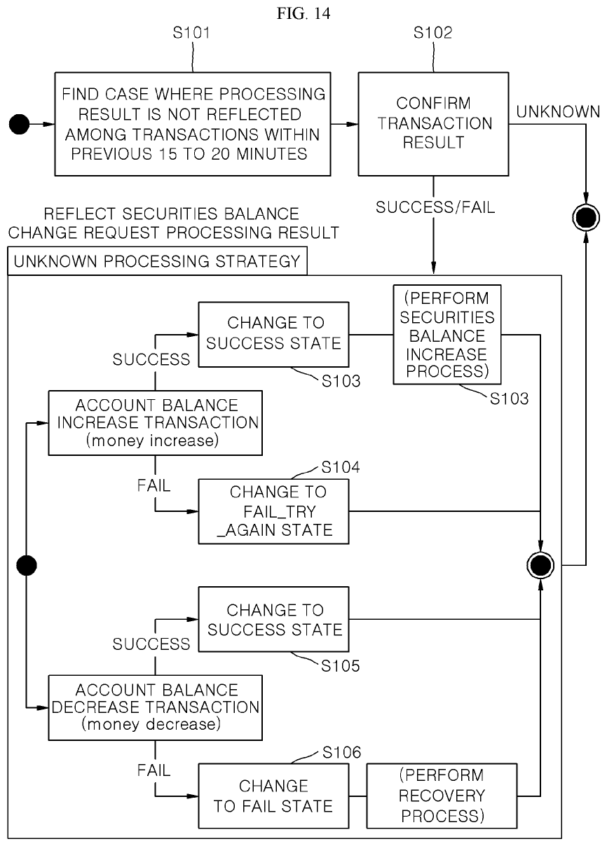

Meanwhile, a case in which the transfer of funds result is not received within a predetermined time due to any problems as described above may occur. It is illustrated as a timeout in the drawing. In this case, the money account remittance may be regarded as success. Note that the above-described operations S51 to S53 are the opposite of being processed as a failure in case of timeout. In the former case, this is because no process that can return is performed. In the latter case, since the securities balance deduction process has already been performed, the money account remittance is once processed as success to quickly return the desired result (i.e., account remittance has been completed normally) to a user. However, since no processing result is reflected in the corresponding message, the internal procedure for processing this is required, which can be performed by the non-reflected case search unit and the non-reflected case processing unit. It will be described below with reference to FIG. 14.

As will be described below, when the money account remittance fails, a recovery process is performed. The recovery of the customer balance, which is deducted from the customer financial company account (for example, securities account) for money account remittance, is requested. The recovery process corresponds to the process of returning the deducted customer balance to its original state.

Conversely, when the money account transfer succeeds, the procedure ends as the account remittance success.

Hereinafter, the entire flow including the above-described process of FIG. 10 and process of FIG. 11 will be described.

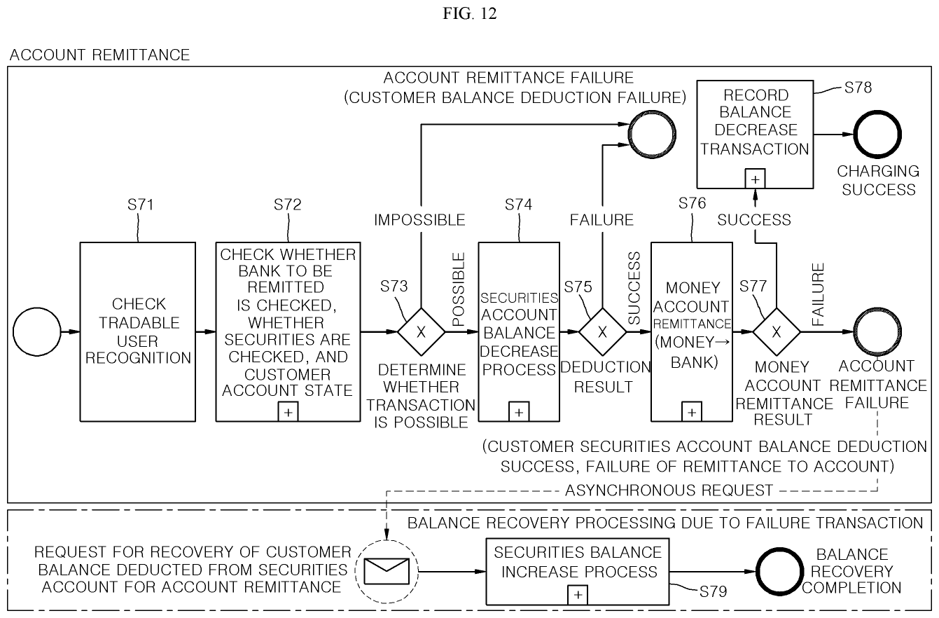

FIG. 12 is a diagram illustrating the overall flow of a process in which a balance of the customer financial company account is deducted and processed by the balance deduction processing unit according to the embodiment of the present invention.

Reference is made to the term “account remittance” in that FIG. 12 illustrates a process of withdrawing funds from the customer financial company account (for example, a securities account) and depositing the funds into the customer-designated account (for example, bank or securities company banks requested by a customer) through the first parent account system (for example, money).

Referring to FIG. 12, first, it is determined whether a user is valid. As an example, an operation S71 of checking whether the user is a tradable user may be performed.

Next, it is determined whether the account is valid. For example, an operation S72 of checking whether the bank linked to the customer-designated account is checked, whether the securities company linked to the customer financial company account is checked, and the state of the customer financial company account may be performed.

The user validity and account validity may be determined based on a previously generated message. The message may be generated by the message generation unit.

It is determined whether the transaction is possible (S73).

As a result of the determination, when the transaction is possible, it proceeds to an operation including the securities balance decrease process of FIG. 10 and the money account remittance process of FIG. 11 described above. As a result of the determination, when the transaction is impossible, the transaction is terminated. It is illustrated as the account remittance failure at the top of the drawing. This is the first embodiment of the account remittance failure, and corresponds to the customer balance deduction failure.

Next, the securities balance decrease process is performed (S74). Operation S74 corresponds to the securities balance decrease process in FIG. 10 described above. That is, the above-described operations S51 to S53 may be performed.

Operation S74 may be performed by the securities firm execution unit 133. Operations S51 to S53 may be performed by the first request recording unit 134, the first processing result receiving unit 135, and the first request processing result reflection unit 136.

The securities balance decrease result is determined (S75).

As a result of the determination, when the securities balance decrease succeeds, the transaction continuously proceeds. As a result of the determination, when the securities balance decrease fails, the transaction is terminated. It is illustrated as the account remittance failure at the top of the drawing. This is the second embodiment of the account remittance failure, and corresponds to the customer balance deduction failure.

Subsequently, the money account remittance process is performed (S76). In the drawing, it is illustrated as the money account remittance (bankmoney). Operation S76 corresponds to the money account remittance process of FIG. 11 described above. That is, the above-described operations S61 to S63 may be performed.

Operation S76 may be performed by the bank firm execution unit 132. Operations S61 to S63 may be performed by the second request recording unit 137, the second processing result receiving unit 138, and the second request processing result reflection unit 139.

The money account remittance result is determined (S77).

As a result of the determination, when the money account remittance succeeds, the account remittance succeeds and thus the transaction is terminated. In this case, the balance decrease transaction recording operation S78 may be additionally performed.

As a result of the determination, when the money account remittance fails, the account remittance fails and thus the transaction is terminated. However, the recovery process may be performed. As described above, since the balance of the customer financial company account has already been deducted, the recovery process proceeds without immediately terminating the transaction. This is a third embodiment of the account remittance failure, and corresponds to a case where the customer securities account balance deduction succeeds but the remittance to the account fails.

The balance recovery processing process due to the account remittance failure is as follows.

The recovery of the customer balance, which is deducted from the securities account for account remittance, is requested. The recovery request is an asynchronous request, and does not have to be made in real time with the account remittance failure, and may be made at any time after the account remittance failure.

The securities balance increase process is performed based on the recovery request (S79). Operation S79 corresponds to the securities balance increase process in FIG. 7 described above. That is, the above-described operations S21 to S23 may be performed.

Operation S79 may be performed by the failed case search unit 1391 and the recovery process unit 1392. The failed case search unit searches for a request of which the processing result is recorded as a failure among the bank firm request logs. The recovery process unit performs the recovery process of recovering the balance deducted from the customer financial company account for the failed case searched by the failed case search unit.

Meanwhile, as described above, the balance increase processing unit 120 includes a non-reflected case search unit 1293 and a non-reflected case processing unit 1294. They operate on the bank firm-request log and the securities firm-request log.

The balance increase processing unit 130 also includes a non-reflected case search unit 1393 and a non-reflected case processing unit 1394 that operate on the securities firm-request log and the bank firm-request log.

Since the operation of the non-reflected case search unit and the non-reflected case processing unit is important for logs, their operations will be described for each log.

First, the operation in the securities firm-request log will be described.

FIG. 13 is a diagram illustrating in detail operations of a non-reflected case search unit and a non-reflected case processing unit with respect to a securities firm-request log according to an embodiment of the present invention.

Referring to FIG. 13, the non-reflected case search unit 1293 searches for a request of which the processing result is not reflected in the securities firm request log (S91). In the drawing, it is illustrated as finding a case where the processing result is not reflected among transaction cases within previous 15 to 20 minutes (find UNKNOWN from securities_firm_request_log). This means that the search period of the non-reflected case search unit may be in the range of 15 to 20 minutes. In the present invention, the request of which the processing result is not reflected is referred to as a non-reflected case.

Next, the non-reflected case processing unit 1294 confirms whether the balance increases (i.e., securities balance increases) according to the execution of the securities firm system SS by the securities firm execution unit 123 for the searched non-reflected case (S92). In the drawing, it is illustrated as the transaction result confirmation (confirm).

As a result of the confirmation, when the securities balance increases, the state of the non-reflected case changes to SUCCESS (S93). It is illustrated as the change to a SUCCESS state in the drawing. It may be reflected in the log by operation S23 of FIG. 7 described above.

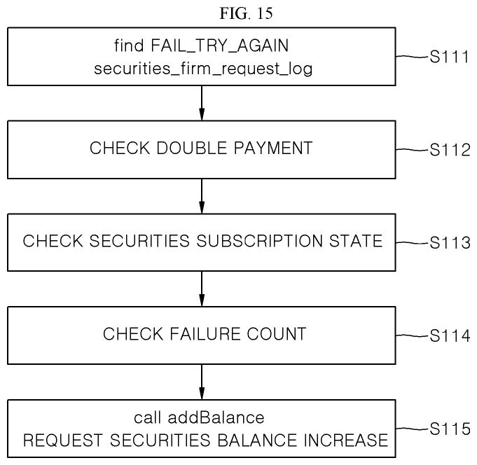

As a result of the confirmation, when the securities balance is not increased, the state of the corresponding non-reflected case changes to FAIL (S94). It is illustrated as the change to FAIL_TRY_AGAIN state in the drawing. It may be reflected in the log by operation S23 of FIG. 7 described above. In this case, the reprocessing process may proceed, which will be described below with reference to FIG. 15.

The above-described operations S91 to S94 are performed in the same manner in the balance deduction process. The differences are mainly described below.

The non-reflected case search unit 1393 searches for the request of which the processing result is not reflected in the securities firm request log (S91). In the drawing, it is illustrated as finding a case where the processing result is not reflected among transaction cases within previous 15 to 20 minutes (find UNKNOWN from securities_firm_request_log).

Next, it is confirmed whether the non-reflected case processing unit 1394 increases the balance (i.e., securities balance deduction) according to the execution of the securities firm system SS by the securities firm execution unit 133 for the searched non-reflected case (S92). In the drawing, it is illustrated as the transaction result confirmation (confirm).

As a result of the confirmation, when the securities balance is deducted, the state of the corresponding non-reflected case changes to SUCCESS (S95). It is illustrated as the change to the SUCCESS state in the drawing. It may be reflected in the log by operation S23 of FIG. 10 described above. In this case, the recovery process may be performed. Since it was regarded as the failure as described above in FIG. 10, the procedure is simplified without reversing the guidance to the user who has failed. The recovery process may include a process of recovering the deducted balance of the customer financial company account. This recovery process may be substantially the same as described above with reference to FIG. 12.

As a result of the confirmation, when the securities balance is not deducted, the state of the corresponding non-reflected case changes to FAIL (S96). It is illustrated as the change to a FAIL state in the drawing. It may be reflected in the log by operation S23 of FIG. 10 described above. Note that there is a difference from being in the FAIL_TRY_AGAIN state in the balance increase processing process described above.

FIG. 14 is a diagram illustrating in detail operations of a non-reflected case search unit and a non-reflected case processing unit with respect to a bank firm-request log according to an embodiment of the present invention.

Referring to FIG. 14, the non-reflected case search unit 1293 searches for message for which the processing result is not reflected in the bank firm request log (S101). In the drawing, it is illustrated as finding the case where the processing result is not reflected in transaction cases within previous 15 to 20 minutes (find UNKNOWN from bank_firm_request_log). In the present invention, the message for which the processing result is not reflected is referred to as a non-reflected case.

Next, the non-reflected case processing unit 1294 confirms whether the transfer of funds (i.e., money charging) according to the execution of the bank firm system BS by the bank firm execution unit 122 for the searched non-reflected case is performed (S102). In the drawing, it is illustrated as the transaction result confirmation (confirm).

As a result of the confirmation, when the money charging is performed, the state of the corresponding non-reflected case changes to SUCCESS (S103). It is illustrated as the change to the SUCCESS state in the drawing. It may be reflected in the log by operation S13 of FIG. 6 described above. In this case, subsequent operations may be followed. That is, the securities balance increase process may be performed. That is, the process after operation S36 of FIG. 8 described above may be performed.

As a result of the confirmation, when the money charging is not performed, the state of the corresponding non-reflected case changes to FAIL (S104). It is illustrated as the change to the FAIL state in the drawing. It may be reflected in the log by operation S13 of FIG. 6 described above.

The above-described operations S101 to S104 are performed in the same manner in the balance deduction processing process. The differences are mainly described below.

The non-reflected case search unit 1393 searches for a request of which the processing result is not reflected in the bank firm request log (S101). Similarly, in the drawing, it is illustrated as finding the case where the processing result is not reflected in transaction cases within previous 15 to 20 minutes (find UNKNOWN from bank_firm_request_log).

Next, the non-reflected case processing unit 1394 confirms whether the transfer of funds (i.e., money account remittance) according to the execution of the bank firm system BS by the bank firm execution unit 132 for the searched non-reflected case is performed (S102). In the drawing, it is illustrated as the transaction result confirmation (confirm).

As a result of the confirmation, when the money account remittance is performed, the state of the corresponding non-reflected case changes to SUCCESS (S105). It is illustrated as the change to the SUCCESS state in the drawing. It may be reflected in the log by operation S63 of FIG. 11 described above.

As a result of the confirmation, when the money account remittance is not performed, the state of the corresponding non-reflected case changes to FAIL (S106). It is illustrated as the change to the FAIL state in the drawing. It may be reflected in the log by operation S63 of FIG. 10 described above. In this case, the recovery process may be followed, and a more detailed description thereof as described above with reference to FIG. 12 will be omitted. Note that, unlike FAIL, the recovery process is performed in the above-described balance increase processing process.

FIG. 15 is a diagram illustrating in detail operations of a failed case search unit and a reprocessing process unit according to an embodiment of the present invention.

As described above, the balance increase processing unit 120 includes the failed case search unit 1291 and the reprocessing process unit 1292. In the case of the balance deduction processing unit 130, there is a difference in that it has a recovery process unit instead of a reprocessing process unit. A more detailed description of the recovery process as described above with reference to FIG. 12 will be omitted.

Referring to FIG. 15, the failed case search unit 1291 searches for a request of which processing result is recorded as failure among the securities firm request logs (S111). In the drawing, it is illustrated as find FAIL_TRY_AGAIN securities_firm_request_log. In other words, it is finding FAIL_TRY_AGAIN instead of FAIL. It is founding the reprocessing target.

Subsequently, the reprocessing process unit 1292 performs the securities balance increase process (S115). It is illustrated as call addBalance securities balance increase request at the bottom of the drawing.

Operation S115 corresponds to the securities balance increase process in FIG. 7 described above. That is, the above-described operations S21 to S23 may be performed. Operations S21 to S23 may be performed by the second request recording unit 127, the second processing result receiving unit 128, and the second request processing result reflection unit 129.

As described above, in the balance increase processing process, since the withdrawal has already been made from the customer-linked account, even if the securities balance increase fails, the reprocessing process proceeds without immediately terminating the transaction, and the reprocessing process may be performed repeatedly until the securities account deposit succeeds.

According to the embodiment of the present invention in the above process, several operations (S112 to S114) may be further performed before performing operation S115.

In detail, after operation S111, it is possible to check whether there is a double payment in the balance (S112). In the drawing, it is illustrated as a check double payment. For example, it may be checked from whether the customer financial company account has already been charged with the same details. For example, it is possible to check whether charging has been performed twice with the same details for one charging request.

Alternatively, after operation S111, it may be checked whether the account is valid (S113). In the drawing, it is illustrated as a check securities subscription state. For example, it may be checked from whether the customer financial company account is valid.

Alternatively, after operation S111, the number of repetitions of the reprocessing process may be counted (S114). In the drawing, it is illustrated as a check failure count. For example, the number of times FAIL_TRY_AGAIN is recorded for one message may be counted. This is because the reprocessing process may not be repeated infinitely. For example, the maximum number of times of repetitions may be set, and it may be determined whether the number of times of failure counts exceeds the predetermined number of times.

When any one of the above operations is not satisfied, final failure processing may be performed, and in this case, the recovery process may be performed in which funds already brought through the previous money charging process are refunded to the customer-linked account.

Meanwhile, although the balance increase process and the balance deduction process were separately described above, they may be performed in parallel or sequentially. For example, when the balance of the customer financial company account is insufficient upon the balance deduction request, the balance deduction process may be performed after the charging through the above-described charging process. For example, when the balance deduction request of the customer is KRW 1.5 million and the balance of the customer financial company account is KRW 500,000, the process of charging KRW 1 million from the customer-linked account to the customer financial company account (i.e., after making the customer financial company account balance KRW 1.5 million) and then processing the balance deduction request by the balance deduction processing unit described above may be performed.

In this case, it is sufficient to further include a deficit processing unit (not illustrated) that calculates the corresponding deficit and enters the charging process of FIG. 8 for the calculated deficit. The same description of the first balance deduction processing unit described above may be applied to the remaining components, and thus, a detailed description thereof will be omitted.

The term “system” used in this document may be a collection in which related elements are combined according to a certain rule in order to realize necessary functions. It may be a small collection (for example, a first parent account system, a second parent account system, a bank firm system, a securities firm system, etc.) in which the related elements are combined in small units, or may be a large collection (for example, financial service provision system) in which all the related elements are combined. The system may include various modules that perform processing for performing financial services, such as transfer processing, on elements included in the system. A module may refer to a unit including one or a combination of two or more of, for example, hardware, software, or firmware. The module may be interchangeably used with terms such as, for example, unit, logic, logical block, component, or circuit.

A server according to an embodiment of the present invention may include a communication unit, a processor, and a memory. For example, the server may be a terminal, such as a computer, in which software or applications are installed. The communication unit is connected to the processor and the memory to transmit and receive data. The communication unit may be connected to another external device to transmit and receive data. Hereinafter, the expression transmitting and receiving “A” may refer to transmitting and receiving “information or data indicating A.” The communication unit may be implemented as circuitry in the server. For example, the communication unit may include an internal bus and an external bus. As another example, the communication unit may be an element that connects the server and an external device. The communication unit may be an interface. The communication unit may receive data from an external device and transmit the data to the processor and the memory. The processor processes the data received by the communication unit and the data stored in the memory. The “processor” may be a data processing device implemented in hardware having a circuitry having a physical structure for executing desired operations. For example, desired operations may include codes or instructions included in a program. For example, a data processing unit implemented in hardware may include a microprocessor, a central processing unit, a processor core, a multi-core processor, a multiprocessor, an application-specific integrated circuit (ASIC), and a field programmable gate array (FPGA). The processor executes a computer readable code (e.g., software) stored in memory and instructions invoked by the processor. The memory stores data received by the communication unit and data processed by the processor. For example, the memory may store a program (or application or software). The stored program or application may be a set of syntaxes that is coded to perform product payment and executable by a processor. According to one embodiment, the memory may include one or more of a volatile memory, a non-volatile memory, and a random access memory (RAM), a flash memory, a hard disk drive, and an optical disk drive. The memory stores the set of instructions (e.g., software or applications) that run the server. The set of instructions that run the server are executed by the processor.

The above-described embodiments of the present invention may be implemented by hardware components, software components, and/or combinations of hardware components and software components. For example, the devices, the methods, and the components described in the embodiments may be implemented using general purpose computers or special purpose computers such as a processor, a controller, an arithmetic logic unit (AUL), a digital signal processor, a microcomputer, a field programmable gate array (FPGA), a programmable logic unit (PLU), a microprocessor, or any other devices that may execute instructions and respond to the instructions. A processing device may execute an operating system (OS) and software applications executed on the operating system. In addition, the processing device may access, store, manipulate, process, and generate data in response to execution of software. Although a case in which one processing device is used is described for convenience of understanding, it may be recognized by those skilled in the art that the process device may include a plurality of processing elements and/or plural types of processing elements. For example, the processing device may include a plurality of processors or one processor and one controller. In addition, other processing configurations such as parallel processors are also possible.

The software may include computer programs, codes, instructions, or a combination of one or more thereof, and may configure the processing device to be operated as desired or independently or collectively command the processing device to be operated as desired. The software and/or the data may be permanently or temporarily embodied in any type of machine, component, physical device, virtual equipment, computer storage medium or device, or transmitted signal wave to be interpreted by the processing device or provide instructions or data to the processing device. The software may be distributed on computer systems connected to each other by a network to be thus stored or executed by a distributed method. The software and the data may be stored in computer-readable recording media.

In addition, embodiments of the present invention may be implemented in a form of program commands that may be executed through various computer means and may be recorded in a computer-readable recording medium. The computer-readable recording medium may include a program instruction, a data file, a data structure or the like, alone or a combination thereof. The program commands recorded in the computer-readable recording medium may be especially designed and configured for the embodiments or be known to those skilled in a field of computer software. Examples of the computer-readable recording medium may include magnetic media such as a hard disk, a floppy disk, or a magnetic tape, optical media such as a compact disk read only memory (CD-ROM) or a digital versatile disk (DVD), magneto-optical media such as a floptical disk, and a hardware device configured to store and execute program commands, such as a ROM, a RAM, a flash memory, or the like. Examples of the program commands include a high-level language code capable of being executed by a computer using an interpreter, or the like, as well as a machine language code made by a compiler. The above-described hardware device may be constituted to be operated as at least one software module to perform operations according to the embodiments of the present invention, and vice versa.

Hereinabove, although the present invention has been described by specific matters such as detailed components, exemplary embodiments, and the accompanying drawings, they have been provided only for assisting in the entire understanding of the present invention. Therefore, the present invention is not limited to the exemplary embodiments. Various modifications and changes may be made by those skilled in the art to which the present invention pertains from this description. Therefore, the spirit of the present invention should not be limited to these exemplary embodiments, but the claims and all of modifications equal or equivalent to the claims are intended to fall within the scope and spirit of the present invention.

### DESCRIPTION OF REFERENCE SIGNS

1: Financial service provision system
10: Customer-linked account
20: Customer financial company account
100: Simple payment company server
110: First parent account system
112: Withdrawal firm parent account
114: Collection parent account
116: Deposit firm parent account
200: Financial company server
210: Second parent account system
212: Financial company parent account
BS: Bank firm system
SS: Securities firm system
120, 130: Balance increase processing unit, balance deduction processing unit
121, 131: Message generation unit
122, 132: Bank firm execution unit
123, 133: Securities firm execution unit
124, 134: First request recording unit
125, 135: First processing result receiving unit
126, 136: Request processing result reflection unit
127, 137: Second request recording unit
128, 138: Second processing result receiving unit
129, 139: Second request processing result reflection unit
1291, 1391: Failed case search unit
1292, 1392: Reprocessing process unit, recovery process unit
1293, 1393: Non-reflected case search unit
1294, 1394: Non-reflected case processing unit

1. A financial service provision system for providing a financial service of attracting funds from customer-linked accounts to manage customer financial company accounts, the financial service provision system comprising:
a simple payment company server that includes a first parent account system including one or more first parent accounts;
a financial company server that includes a second parent account system including one or more second parent accounts;
a bank firm system that manages a transfer of funds between the customer-linked account and the first parent account system or between a customer-designated account designated by a customer and the first parent account system; and
a securities firm system that manages the transfer of funds between the second parent account system and the customer financial company account,
wherein, when the customer requests a change in balance, the change in balance is processed through the bank firm system and the securities firm system to change the balance of the customer financial company account.

2. The financial service provision system of claim 1, further comprising:
a balance increase processing unit that performs processing of withdrawing the funds from the customer-linked account using the bank firm system and processing of increasing the balance of the customer financial company account using the securities firm system when the customer requests an increase in the balance; and
a balance deduction processing unit that performs processing of remitting the funds to the customer-designated account using the bank firm system and processing of deducting the balance of the customer financial company account using the securities firm system when the customer request the balance deduction.

3. The financial service provision system of claim 2, wherein the first parent accounts include a withdrawal firm parent account, a collection parent account, and a deposit firm parent account, and
the second parent accounts include a financial company parent account.

4. The financial service provision system of claim 3, wherein the balance increase processing unit includes:
a message generating unit that generates a balance increase request-related message;
a bank firm execution unit that executes the bank firm system based on the message to transfer the funds from the customer-linked account to the withdrawal firm parent account; and
a securities firm execution unit that executes the securities firm system based on the message to increase the balance of the customer financial company account through a transfer transaction between the financial company parent account and the customer financial company account.

5. The financial service provision system of claim 4, wherein the balance increase processing unit further includes:
a first request recording unit that records a request in a bank firm-request log based on the generated message;
a first processing result receiving unit that receives a transfer of funds processing result according to the execution of the bank firm system; and
a first request processing result reflection unit that reflects the received processing result in the bank firm-request log.

6. The financial service provision system of claim 5, wherein the balance increase processing unit further includes:
a second request recording unit that records a request in a securities firm-request log based on the generated message;
a second processing result receiving unit that receives a balance increase processing result according to the execution of the securities firm system; and
a second request processing result reflection unit that reflects the received processing result in the securities firm-request log.

7. The financial service provision system of claim 6, wherein the balance increase processing unit further includes:
a failed case search unit that searches for a failed request of which the processing result is recorded as failure in the securities firm-request log; and
a reprocessing process unit that performs a reprocessing process on the failed request by the second request recording unit, the second processing result receiving unit, and the second request processing result reflection unit.

8. The financial service provision system of claim 7, wherein the balance increase processing unit further includes:
a non-reflected case search unit that searches for a non-reflected request of which the processing result is not reflected in the securities firm-request log; and
a non-reflected case processing unit that confirms whether the balance increases according to the execution of the securities firm system on the non-reflected request by the securities firm execution unit, changes a state of the non-reflected case to a success state when the balance is increased as a result of the confirmation, and changes the state of the non-reflected case to a failure state when the balance is not increased.

9. The financial service provision system of claim 3, wherein the balance deduction processing unit includes:
a message generation unit that generates a balance deduction request-related message;
a bank firm execution unit that executes the bank firm system based on the message to transfer the funds from the deposit firm parent account to the customer-designated account; and
a securities firm execution unit that executes the securities firm system based on the message to deduct the balance of the financial company parent account through a transfer transaction between the financial company parent account and the customer financial company account.

10. The financial service provision system of claim 9, wherein the balance deduction processing unit further includes:
a first request recording unit that records a request in a securities firm-request log based on the generated message;
a first processing result receiving unit that receives a balance deduction processing result according to the execution of the securities firm system; and
a first request processing result reflection unit that reflects the received processing result in the securities firm-request log.

11. The financial service provision system of claim 10, wherein the balance deduction processing unit further includes:
a second request recording unit that records a request in a bank firm-request log based on the generated message;
a second processing result receiving unit that receives a transfer of funds processing result according to the execution of the bank firm system; and
a second request processing result reflection unit that reflects the received processing result in the bank firm-request log.

12. The financial service provision system of claim 11, wherein the balance deduction processing unit further includes:
a failed case search unit that searches for a failed request of which the processing result is recorded as failure in the bank firm-request log; and
a recovery process unit that performs a recovery process of recovering the deducted balance of the customer financial company account on the failed request.

13. The financial service provision system of claim 12, wherein the balance deduction processing unit further includes:
a non-reflected case search unit that searches for a non-reflected request of which the processing result is not reflected in the bank firm-request log; and
a non-reflected case processing unit that confirms whether the transfer of the funds is performed according to the execution of the bank firm system by the bank firm execution unit for the non-reflected request, changes a state to success for the non-reflected request when the transfer of the funds is performed as a result of the confirmation, and changes the state of the non-reflected case to a failure state when the transfer of the funds is not performed.

14. The financial service provision system of claim 1, wherein the first parent account system includes a plurality of withdrawal firm parent accounts issued by different financial companies, and
the bank firm system processes the transfer of the funds using a withdrawal firm parent account issued by the same financial company as the customer-linked account among the plurality of withdrawal firm parent accounts.

15. A simple payment company server for providing a financial service of attracting funds from a customer-linked account to deposit the attracted funds into a customer financial company account, wherein the simple payment company server is connected, through a network, to a financial company server including:
a first parent account system that includes one or more first parent accounts; and
a second parent account system that includes one or more second parent accounts,
when a customer requests a change in balance, a balance of the customer financial company account is changed through a bank firm system that manages a transfer of funds between the customer-linked account and the first parent account system or a transfer of funds between a customer-designated account designated by the customer and the first parent account system and a securities firm system that manages a transfer of funds between the second parent account system and the customer financial company account.

16. A financial company server for providing a financial service of attracting funds from a customer-linked account to deposit the attracted funds into a customer financial company account, wherein the financial company server is connected, through a network, to a simple payment company server including:
a first parent account system that includes one or more first parent accounts; and
a second parent account system that includes one or more second parent accounts, and
when a customer requests a change in balance, a balance of the customer financial company account is changed through a bank firm system that manages a transfer of funds between the customer-linked account and the first parent account system or a transfer of funds between a customer-designated account designated by the customer and the first parent account system and a securities firm system that manages a transfer of funds between the second parent account system and the customer financial company account.
